(19) United States
(12) Patent Application Publication
(10) Pub. No.: US 2008/0249265 A1
(43) Pub. Date: Oct. 9, 2008

(54) Method For Triggering Radical Polymerization Reactions

(76) Inventors: Markus Bischof, Warthausen (DE); Fritz Mezger, Schoenaich (DE); Thomas Raith, Westerstetten (DE); Christoph Ruechardt, Stegen (DE)

Correspondence Address: PATENT CENTRAL LLC;Stephan A. Pendorf, 1401 Hollywood Boulevard, Hollywood, FL, 33020, US

(21) Appl. No.: 10/562,234

(22) PCT Filed: May 6, 2004
(86) PCT No.: PCT/EP04/04827

§ 371 Date: Oct. 24, 2007

(30) Foreign Application Priority Data
Jun. 25, 2003 (DE) 103 28 473.7

(51) Int. Cl. C08F 4/42

(52) U.S. Cl. 526/147

(57) ABSTRACT

The invention relates to an initiator system for triggering a radical polymerization reaction of a preparation that contains monomers and/or oligomers having ethylenically unsaturated groups. The initiators used are open-chain and/or cyclic N,N-diacylhydroxylamines of the general formula R—CO—N(OH)—Co—R′. The invention also relates to a method for starting a radical polymerization reaction by way of the thermally initiated formation of oxyl radicals from open-chain and/or cyclic N,N-diacylhydroxylamines or the O-alkyl or O-acyl derivatives thereof having the general formulae R—CO—N(OH)—CO—R′, R—CO—N(O—R)—CO—R′ or R—CO—N(O—CO—R′)—CO—R′, wherein R, R′R and R′ are the same or different organic substituents and R can be linked with R′.

### CROSS REFERENCE TO RELATED APPLICATION

This application is a national stage of PCT/EP2004/004827 filed May 6, 2004 and based upon DE 103 28 473.7 filed Jun. 25, 2003 under the International Convention.

### BACKGROUND OF THE INVENTION

1. Field of the Invention

The invention concerns an initiator system for thermal initiation of a radical polymerization of preparations, in particular lacquers or paints, coating solutions, coating compositions, molding materials, fillers and adhesives, which contain monomers and/or oligomers with ethylenically unsaturated groups, which in particular are formed by acrylate and methacrylate derivates, as well as a process for radical polymerization of the preparations under inert gas or in air.

2. Related Art of the Invention

Materials curable by polymerization have broad applications, in particular as mold materials, however also in the case of lacquers, paints, coatings and adhesives. Therein radical polymerization of radical polymerizable components, for example of (meth)acrylate compounds, is very frequently selected as the curing mechanism. (“(Meth)acrylate” refers to both methacrylate and acrylate.) Therein the polymerization is most commonly initiated thermally or photochemically, for example by UV-light.

Particularly in the case of layer forming applications (paints, coatings, etc.), however the exposure to oxygen over a large exposed surface area results in an interference in the radical polymerization. The oxygen contributes in its activity as radical scavenger to a strong inhibition of the polymerization, which thus frequently exhibits itself as an incomplete curing and in particular in the form of tacky coating surfaces. This is also known in the case of peroxides and azo compound thermal hardening systems. In particular in the case of methacrylate containing preparations the photochemical initiated polymerization provides an important process variant, since this provides comparatively good material characteristics.

The inhibition by air can be counteracted in part by the employment of high amounts of photo initiators, co-initiators, high radiation powers or waxes forming cover-coatings. In DE 199 57 900 A1 it is further disclosed that the influence of air can be reduced by a gas cushion of inert gas. The inert gas is therein comprised preferably of CO₂, which on the basis of a high specific weight allows itself to be employed as a gas cushion.

The photo-initiated (radiation induced) polymerization has, in comparison to a thermal initiated polymerization, the disadvantage that an even radiation is very difficult to achieve or even impossible in the case of geometrically complex shapes due to the occurrence of shaded areas. In particular during the spraying on of lacquers or paints there frequently occurs undesired precipitation of atomized spray in shadow areas which were not intended to be painted.

It would thus be desirable, in particular already in the time tested and well proven radiation hardening preparations with monomers and/or oligomers, which include ethylenically unsaturated groups, to make these available or utilizable in thermal polymerization under the influence of air. The measures carried out for minimization of the oxygen inhibition for the photochemical initiation could in principle also in analogous manner be applied or transferred to the thermal initiated polymerization. They are however associated in part with substantial technical and material disadvantages. Thus, for example, the increase in the initiator activity leads even in the case of room temperature to a premature undesired polymerization.

### SUMMARY OF THE INVENTION

It is thus the task of the invention to provide a highly storage stable initiator system for the thermal initiated polymerization of preparations with ethylenically unsaturated groups in air or under inert gas, which starts at low temperatures, as well as a suitable process for thermal initiated curing of preparations with radical polymerizable groups.

In accordance with the invention there is provided an initiator system which includes or exhibits as initiator a radical forming group of activatable hydroxylamine, O-alkylhydroxylamine, or O-acylhydroxylamine derivatives. Therein the activation of these groups is affected in accordance with the invention by two acyl groups linked to the N. The central structural unit of the initiator is cumulatively provided by the following general formulas:

N,N-diacylhydroxylamine: R—CO—N(OH)—CO—R′ (1)

### O-alkylated N,N-diacylhydroxylamine:

R—CO—N(O—R″)—CO—R′ (2)

### O-acylated N,N-diacylhydroxylamine:

R—CO—N(O—CO—R′″)—CO—R′ (3)

R, R′, R″ and R′″ mean the same or different organic substituents. R, R′, R″ and/or R′″ are in particular selected from the group of aliphatic, linear, branched and/or cyclic substituted and/or unsubstituted hydrocarbons. R, R′ and/or R′″ can therein also be an aromatic hydrocarbon, for example a phenyl residue.

Preferably R, R′, R″ and/or R′″ include hydrocarbon chains with a chain length of 2 to 18 atoms. The hydrocarbon chains can in certain cases also be interrupted by heteroatoms from the group N, O and/or S. In particular for R″ organic substituents are of significance. For example R, R′, R″ or R′″ can be derivatives of natural fatty acids.

In a preferred embodiment of the invention the residues R and/or R′ are closed into a chain, of which the length is 2 to 10 atoms. The initiator is indicated by the following general schematic formula (4), wherein the closed chain is represented by z and z represents a number of chain atoms. z is preferably between z=2 to z=10.

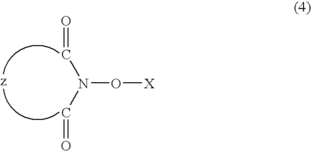

Particularly preferred herein are cyclic N,N-diacylhydroxylamine or N,N-diacyl derivatives with a ring size of 5 to 12 atoms. X represents therein in accordance with the formulae (1), (2) or (3) —H, —R″, or —CO—R′″. Particularly preferred is when X is —H.

In a further preferred embodiment of the invention the two residues R and R′ form a closed ring system wherein the N,N-diacylhydroxylamine grouping is joined via an acyl group to the ring system. The initiator can be indicated by the following general schematic formula (5).

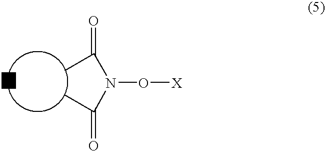

Herein X means as Formula (1), (2) or (3) —H, —R″ or —CO—R′″. In (5) z represents a cyclic hydrocarbon with at least 4 and preferably 6 to 14 ring atoms. The chain links or elements or members of z are preferably formed by methylene and/or alkylene groups, which may have side chains or as the case may be side substituents. In certain cases one or more of the carbon atoms of the ring are substituted by a heteroatom. Particularly preferred is when the ring z represents an aromatic ring system with 5 to 8 ring atoms, for example the system on the basis of benzol, naphthylene or anthracene.

Included in the inventive suitable compounds according to schematic formula (5) there are in particular also the derivatives on the basis of benzoltricarboxylics, phthalic acids, homophthalic acids and pyromellitic acid. While two adjacent carboxylic groups form the N,N-Diacyl group, the third carboxylic function is available as active group for a further derivativation.

From EP 0 424 115 B1 electrophotographic photosensitive compounds are known, which as active group likewise exhibit an N,N-diacylhydroxylamine group. Herein these are ring systems in which the grouping either is present as a component of the ring or as an analog. The range of the inventive compounds suitable as thermal initiator for the radical polymerization extends to the Formulas 1 to 104 illustrated in EP 0 424 115 B1, as well as their O-alkyl or O-acyl derivatives, according to the general Formulae (2) or (3).

Depending upon whether the initiator system is to be employed in a non-polar organic medium or in a polar aqueous medium, the solubility can be adjusted on the basis of a suitable selection of substituents of R and/or R′, respectively z. For non-polar media there are preferred for example aliphatic or aromatic substituents. For polar media, in particular aqueous media, preferred are substituents with hydroxyl, carboxyl, alkyleneglycol and/or keto groups.

The inventive particularly preferred compounds include N-hydroxyl-phthalimide, N-hydroxyl-succinamide and their derivatives, as well as N-hydroxyl amide, the dicarboxylics endo-bicyclo[2.2.1]hept-5-en-2,3-dicarboxylics, endo-bicylo[2.2.1]heptan-2,3-dicarboxylics or cis-cyclohex-3-en-1.6-dicarboxylics. The particularly preferred O-acylated compounds (triacylhydroxylamine) include tributyroylhydroxylamine and N-hydroxyl-phthalimide O-acylated with acetyl or propionyl.

The inventive initiator system can include as further components a co-initiator which supports the activity of the initiator. While in the case of the N,N-diacylhydroxylamine a co-initiator free initiator can lead to polymerization and curing, in the case of the O-acylated N,N-diacylhydroxylamine and for the O-acylated N,N-diacylhydroxylamine the use of a co-initiator is generally necessary.

Preferred co-initiators are formed by active metal ions and/or by tertiary amines. Although certain of the initiators are likewise capable of initiating polymerization without co-initiators, the co-initiators bring about however a substantial reduction in the curing temperature.

In the case of the metal ions as co-initiator, the formation of the starter radical, which initiates the polymerization of the polymerizable components, is supported. In the reaction the active metal ion of the co-initiator alternates between a higher and a lower oxidation level. The oxidation in the higher oxidation level can occur by oxygen. Therefrom there results a substantial advantage in comparison to the known initiator systems, in which the atmospheric oxygen exerts a primarily inhibiting effect and interferes with polymerization. In the inventive initiator system with co-initiator the oxygen in contrast has an effect of supporting the initiation reaction.

In comparison to the known systems, the inventive initiator systems are also suitable for thermal initiated polymerization in air. This is a substantial process advantage, which is of particular significance for polymerizable preparations spread out over a large surface area, such as lacquers or paints or surfaces of mold materials or coatings, which expose large surface areas to ambient air. This is likewise of significance the case for atomized paint, which is deposited in difficult to access areas. Incomplete curing or tacky paint surfaces can substantially be avoided with the inventive initiator system.

Metal ions suitable as the active metal ion of the co-initiator exhibit in general multiple oxidation levels, which, with respect to their electrochemical potential, lie close together. The oxidation levels should be easily transitionable by reaction with initiator or, as the case may be, oxygen. The corresponding metals are typically found among the transition metals. Preferred are metals with at least two oxidation levels in the range of I to VIII, for example, the transition metals Ti, V, Cr, Mo, W, Mn, Fe, Co, Rh, Ir, Ni, Ir, Pd, Pt and/or Cu. Particularly preferred are cobalt ions with the oxidation potential II or III, in certain cases with further or additional metal ions. As additional metal ions of the co-initiator there can be contained ions of the alkaline or earth alkaline metals, for example Li, K, Ca, Sr, Ba as well as Bi, Pb, Zn, Cu, Zr and/or Ce, which improve the effectiveness of the co-initiator.

Generally the metal ions are found bonded in a complex. In organic medium the metal ions can be employed for example as carboxylic salts of fatty acids or as acetylacetonate. Likewise theye are also suitable as porphine complexes, for example a tetraphenylporphine complex or a metal salt of naphthenate. Preferred are the acetate or octanoate of Mn or Co in the oxidation level (II) and/or (III).

As further suitable co-initiators there are tertiary amines, which are typically known as amine accelerators. These include for example dimethyl aniline, N,N-dimethyl-p-toluidine, and N,N′-bis(2-hydroxypropyl)-p-toluidine. Further preferred tertiary amines include N-methyl pyrrolidine and/or diazabicyclooctane (DABCO).

A preferred use of the inventive initiator system lies in the curing of polymerizable preparations, which include monomers or oligomers (also referred to as pre-polymers) with ethylenically unsaturated groups, such as in particular (meth)acrylate, vinylester, vinylether, acrylamide, vinylchloride, acrylonitrile, butadiene, unsaturated fatty acids, styrol derivatives, maleinic acid or fumaric acid groups. Typical representatives of the oligomers which carry these reactive groups include polyester, polyurethane, alkyd resins, epoxides, polyethers or polyolefines.

The preparation can contain, besides the components which are radical polymerizable by means of the inventive initiator system, in certain cases also further reactive components or groups, which are suitable for the curing reaction. For example also polyol groups and isocyanate groups can be included, which cure to form urethanes.

The particularly interesting uses of the initiator system include the hardening of lacquers or paints, coating solutions, adhesives and resins, as they are known in similar compositions already in photochemical hardener embodiments. The amounts of initiator necessary for radical initiation lie therein in general at the amounts necessary for photochemical polymerization.

If the inventive initiator system is used in combination with conventional radical initiators on the basis of peroxides or azo compounds, then even small amounts of less than 0.5 wt. % suffice for initiation of polymerization at significantly reduced temperatures. This applies also for radical initiators with C—C bond splitting such as for example benzpinakolsilylether.

Further uses lie in the manufacturer of curable shaped parts, dental shapes or prosthesis, fillers, sheet molding compounds (SMC), sealing coatings in the electronic industry and matrix or embedding materials.

Generally the inventive initiator system, comprised of starter and co-initiator, is employed in an amount of 0.1 to 8 wt. % of the amount of the polymerizable preparation.

A further aspect of the invention concerns a process for curing of preparations with radical curable components by means of radical polymerization under the influence of oxygen. These include also those conditions which simply bring about a reduction of the oxygen content without however producing a completely oxygen-free atmosphere. Thus, the use of an inert flushing gas, such as CO₂, argon or N₂, leads in general not to a complete exclusion of the presence of oxygen from the gas environment, so that the preparation then, as before, is under the influence of oxygen.

It is however of significance to note that inert gas conditions in general provide a clearly better quality at lower temperatures.

In accordance with the invention it is envisioned that the polymerization is started by a thermal initiated formation of radicals of initiators, which in certain cases are supported by co-initiators.

The inventive radicals are substantially oxyl radicals, which are formed from the open-chain and/or cyclic N,N-diacylhydroxylamines and/or their O-alkyl or O-acyl derivatives with the general formulae

R—CO—N(OH)—CO—R′ (1),

R—CO—N(O—R″)—CO—R′ (2)

Or R—CO—N(O—CO—R′″)—CO—R′ (3)

(cumulatively referred to as initiators).

The oxyl radicals technically originate from the linkage breakage from the O—H, O—R″ or the O—CO—R′″ linkages of the above illustrated general formulae (1), (2) or (3). As for the meanings of the residues R, R′, R″ and R′″, the definitions set forth above apply.

Therein the formation of the oxyl radicals can, in accordance with the invention, be supported by a co-initiator. The co-initiator includes a metal ion, which is reduced in the step of the radical formation of the N,N-diacylhydroxylamine and/or their O-alkyl or O-acyl derivative from a higher to a lower oxidation level. In the O-alkyl or the O-acyl derivatives in general the use of a co-initiator cannot be dispensed with.

The co-initiator in particular contains active metal salts, of which the metal ions can be reduced by N,N-diacylhydroxylamine. Particularly preferred for employment as co-initiators are organic compounds of complex bound transition metal ions of oxidation levels II through V. Particularly preferred co-initiators therein are Co (II)-carboxylic salts.

The amounts of the necessary initiators and co-initiators depends among other things upon the type and the amount of the polymerizable compounds of the preparation, and the reaction conditions, in particular temperature and oxygen content.

Typically the preparation includes the initiator system therein, the polymerizable compound (components), solvent and the conventional additives. The conventional additives include in particular inorganic fillers and additives for the optimization of rheologic or surface quality, polymers, metallic or ceramic fillers, pigments, stabilizers and UV-absorbers. The radical curable components include in particular the already described monomers or oligomers with ethylenic unsaturated groups.

Typically the total amount of the initiator system of starter and co-initiator lies in the range of 0.1 to 8 wt. % of the total preparation. Therein the amount of the co-initiators preferably lies in the range of from 0.5 to 80 wt. % of the initiator system.

Formulations with conventional radical initiators (azo- or peroxide compounds) can already tend towards creeping polymerization at room temperature. The formulation with the inventive initiator system exhibits, in comparison, a comparatively good storage stability.

In one embodiment of the inventive process, in particular in the case of very reactive monomers and/or oligomers, the co-initiator is added only immediately prior to the desired curing. In particular a two-component technique is provided or envisioned, in which a first component, which includes the total co-initiator dissolved in the solvent and a second component, which includes the total ethylenic unsaturated compound and the initiator, are mixed together only immediately prior to the use of the preparation. Herein a further advantage of the inventive initiator system is exhibited. The co-initiator free mixture of polymerizable preparation and initiator are also highly storage stable at higher initiator concentrations, without a premature or creeping polymerization taking place.

It is likewise possible to incorporate the total initiator in the monomer or oligomer free component. The co-initiator can be added dissolved in solvent prior to use.

In a further embodiment of the two-component technique the preparation is divided into two monomer-containing (or, as the case may be, oligomer-containing) components, of which one contains the inventive initiator and the other the co-initiator.

In one further embodiment of the invention the polymerization and curing process is supported by additional thermal radical initiators, in particular based upon peroxides, azo compounds or C—C bond splitting initiators contained in the initiator system.

The process for initiation of polymerization envisions a warming of the initiator containing preparation to temperatures above 70° C. The temperature range preferred for initiation of radical formation preferably lies at 90 to 150° C., wherein here also the reactivity of the monomers or oligomers is of significance. Therein the initiator is likewise also suitable for significantly higher temperatures, as can occur for example in conveyor coatings at temperatures of 200° C. The comparatively low initiation temperature compared to the known systems provides a further advantage of the invention.

In high reactive resins and with the use of additional initiators on the basis of azo or peroxo compounds, which as a rule are employed as two-component systems, initiation temperatures below 70° C. are also possible as initiation temperatures. This is desirable for example for dental shapes or prosthesis.

A further advantage of the inventive process lies in the high tolerance with regard to the oxygen content of the environmental air. For carrying out the inventive polymerization initiation the oxygen contents can generally be in the range of from 25 to approximately 0.01 vol. %. In general, a better paint quality is achieved at low firing temperatures and in inert gas conditions.

In a further advantageous embodiment of the inventive process dual-cure systems are employed. These initiator systems contain as additional components UV-initiators, which initiate polymerization by means of energy-rich light, in particular UV-light.

A further variant of the process envisions carrying out first a partial polymerization (pre-polymerization) of the preparation by means of energy-rich light or UV-light and thereupon a thermal initiated follow-up or final polymerization at elevated temperature by the inventive initiator system. This process has the advantage that typical UV-paints are completely hardened even in the shadow area.

A second variant of the process envisions that the UV-hardening is carried out during, or subsequent to, the thermal hardening. This has the effect that the UV-light facing (upper lying) layer of the preparation is hardened only towards the end of the process.

### EXAMPLES

For explaining the influence of the initiator system and the concentration thereof upon the initiation temperature of the radical polymerization, a series of tests were carried out with a standard preparation. The standard preparation corresponds to a substantially generally employed conventional preparation for UV-paints, without UV-initiators.

Composition of the standard preparation:
60 parts Ebecryl 5129 (manufacturer: UCB)
20 parts Ebercyl 284
20 parts Ebercyl 40
40 parts Xylol
20 parts butylacetate
1 part Tinuvin 292 (manufacturer: Ciba Chemicals)
1.5 part Tinuvin 400

### Example 1

In a first test series the influence of different co-initiators (co-octanoate) where examined at the same initiator content (1 wt. % N-hydroxysuccinimide) and two different reaction temperatures (130° C., 100° C.) on the basis of the micro-hardness of the formed polymerisate (paint layer) after a ten minute reaction duration. The results in Tables 1 and 2 show that the hardness of the standard preparation is substantially elevated with increasing co-initiator content at otherwise identical conditions.

TABLE 1
Reaction Temperature 130° C.; Reaction Time 10 min.

| | | | | |
|---|---|---|---|---|
| Co-Octanoate | 0 | 0.01 | 0.02 | 0.03 |
| (wt. %) | | | | |
| Micro hardness | 0 | 110 | 150 | 140 |
| [N/mm²] | | | | |

TABLE 2
Reaction Temperature 100° C.; Reaction Time 10 min.

| | | | | |
|---|---|---|---|---|
| Co-Octanoate | 0 | 0.01 | 0.02 | 0.03 |
| (wt. %) | | | | |
| Micro hardness | 0 | 0 | 80 | 120 |
| [N/mm²] | | | | |

For the test without co-initiator, the initiation temperature which led to a hard surface was above 150° C.

### Example 2

In further test series the influence of different initiator contents (N-hydroxylsuccinimide) were tested at identical co-initiator amounts (0.02 wt. % co-octanoate) at two reaction temperatures (130° C., 100° C.) and on the basis of micro hardness of the formed polymerizate after ten minute reaction duration were examined. The results presented in Tables 2 and 3 show that the hardness of the standard preparation is substantially increased with increasing initiator content with otherwise identical conditions.

TABLE 3
Reaction Temperature 130° C.; Reaction Time 10 min.

| | | | | |
|---|---|---|---|---|
| N- | 0.1 | 0.3 | 0.5 | 1 |
| Hydroxylsuccinimide | | | | |
| (wt. %) | | | | |
| Micro hardness | 35 | 90 | 105 | 150 |
| [N/mm²] | | | | |

TABLE 4
Reaction Temperature 100° C.; Reaction Time 10 min.

| | | | | |
|---|---|---|---|---|
| N- | 0.1 | 0.3 | 0.5 | 1 |
| Hydroxylsuccinimide | | | | |
| (wt. %) | | | | |
| Micro hardness | 30 | 70 | 80 | 80 |
| [N/mm²] | | | | |

1-22. (canceled)

23. An initiator system for initiation of a radical polymerization of a preparation comprising at least one of monomers and oligomers which include ethylenic unsaturated groups, said initiator system comprising:
an open-chain and/or cyclic N,N-diacylhydroxylamine of the general formula R—CO—N(OH)—CO—R′, wherein R and R′ are selected from the group of aliphatic, linear, branched and/or cyclic and/or aromatic hydrocarbons and R and R′ may be linked with each other forming a ring, and
co-initiators which contain metal ions with multiple oxidation levels in the range of from 1 to 8 or tertiary amines.

24. An initiator system according to claim 23, wherein R, R′, R″ and/or R′″ are hydrocarbon chains with a chain length of 2 to 18 atoms.

25. An initiator system according to claim 24, wherein the group X is comprised of an alkyl residue with 1 to 6 C atoms or an aliphatic, aromatic or heteroaromatic acyl residue with at least 2 C-atoms.

26. An initiator system according to claim 23, wherein the co-initiator contains metal ions from the group Ti, V, Cr, Mo, W, Mn, Fe, Co, Rh, Ir, Ni, Pd, Pt and/or Cu.

27. An initiator system according to claim 26, wherein the co-initiator contains metal ions from the group alkali, earth alkali as well as Bi, Pb and/or Ce.

28. An initiator system according to claim 23, wherein the residues R and R′ are linked to form a chain of from 2 to 10 atoms.

29. An initiator system according to claim 23, wherein the residues R and R′ contain at least one hetero atom from the group N, O and S and are joined to each other, so that a cyclic N,N-diacylhydroxylamine or N,N-diacylhydroxylamine derivative with a ring size of 5 to 12 atoms is formed.

30. An initiator system according to claim 23, wherein the residues R and R′ form a closed ring system with 5 to 12 ring atoms, to which the N,N-diacylhydroxylamine group, or the derivative thereof, is joined via their acyl groups.

31. An initiator system according to claim 23, wherein the cyclic N,N-diacylhydroxylamine or the derivatives thereof are formed by N-hydroxyl-phthalimide, N-hydroxylmaleinimide or hydroxamic acid and/or N-hydroxyl-succinimide.

32. An initiator system according to claim 23, wherein the initiator system includes air or O₂.

33. An initiator system according to claim 23, wherein the radical initiator system includes additional radical initiators on the basis of peroxides, azo compounds or C—C-bond splitting initiators.

34. An initiator system for initiation of a radical polymerization of a preparation comprising at least one of monomers and oligomers which include ethylenic unsaturated groups, said initiator system comprising:
open-chain and/or cyclic O-alkylated or O-acylated N,N-diacylhydroxylamine of the general formula R—CO—N(OH)—CO—R′, and
co-initiators which form a complex with metal ions with multiple oxidation levels in the range of from 1 to 8, wherein X represents —H, —R″ or —CO—R′″ and R, R′, R″ and R′″ are the same or different organic substituents selected from the group of aliphatic, linear, branched and cyclic, substituted or unsubstituted hydrocarbon, and aromatic hydrocarbons, and R and R′ can be joined to each other to form a ring.

35. An initiator system according to claim 33, wherein the metal ions are selected from the group of the transition metals and are oxidizable by atmospheric oxygen and reducible by N,N-diacylhydroxylamine.

36. A process for initiation of a radical polymerization of polymerizable compounds with ethylenic unsaturated groups under the influence of oxygen, comprising substantially thermal initiated polymerization by formation of oxyl-radicals of open-chain and/or cyclic N,N-diacylhydroxylamines or their O-alkyl or O-acyl derivatives with the general formula R—CO—N(OH)—CO—R′, R—CO—N(O—R″)—CO—R′ or R—CO—N(O—CO—R′″)—CO—R′, with the aid of co-initiators, which include metal ions with multiple oxidation levels in the range of 1 to 8, wherein R, R′, R″ and R′″ mean the same or different organic substituents selected from the group aliphatic, aromatic, linear, branched and cyclic, substituted and unsubstituted hydrocarbon, wherein R and R′ may be joined to each other to form a ring.

37. A process according to claim 36, wherein the formation of the oxyl radical is coupled with the reduction of metal ions of a co-initiator from a higher into a lower oxidation level.

38. A process according to claim 37, wherein metal salts are employed as co-initiator, of which the metal ions can be transitioned by N,N-diacylhydroxylamine from a higher to a lower oxidation level.

39. A process according to claim 36, wherein the residues are organic residues, wherein R, R′, R″ and/or R′″ are aliphatic or, with the exception of R″, aromatic, and can contain hetero atoms.

40. A process according to claim 36, wherein the temperature for initiation is below 150° C.

41. A process according to claim 36, wherein the oxygen content in the gas environment of the polymerizable compound lies in the range of 25 to 0.01 Vol. %.

42. A process according to claim 36, wherein the preparation contains a UV-initiator and prior, during or subsequent to the initiation of the thermal initiated polymerization is partially irradiated with energy rich light or UV-light.
